(19) United States
(12) Patent Application Publication
(10) Pub. No.: US 2026/0204833 A1
(43) Pub. Date: Jul. 16, 2026

(54) CONNECTOR

(71) Applicant: Yazaki Corporation, Tokyo (JP)

(72) Inventors: Daiki Ito, Makinohara-Shi (JP); Takeo Ida, Sagamihara-shi (JP)

(21) Appl. No.: 19/430,828

(22) Filed: Dec. 23, 2025

(30) Foreign Application Priority Data
Jan. 14, 2025 (JP) 2025-004599

(51) Int. Cl. H01R 13/506

(52) U.S. Cl. CPC H01R 13/506

(57) ABSTRACT

A connector according to one embodiment includes a housing having a housing main body and a hood portion, and a rear holder inserted and fitted into the hood portion along a first direction. The housing includes an erroneous insertion preventing portion that is provided inside the hood portion and protrudes toward a side where the rear holder is inserted along the first direction, and a restraining portion that is provided inside the hood portion and restrains the rear holder from moving in a direction of being removed from the hood portion. The rear holder includes an insertion portion that has a wiring insertion portion and is inserted into the hood portion, and a lock arm elastically deformable in a second direction and engageable with the restraining portion.

### BACKGROUND OF THE INVENTION

### Field of the Invention

Embodiments of the present invention relate to a connector.

Priority is claimed on Japanese Patent Application No. 2025-004599 filed in Japan on January 14, 2025, the content of which is incorporated herein by reference.

### Description of Related Art

There has been known a connector that provides a positioning rib on a hood wall of an electric wire connection portion to prevent erroneous insertion of a rear holder.

### PRIOR ART DOCUMENT

### Patent document

Patent Document 1: Japanese Unexamined Patent Application, First Publication No. H8-98372

### SUMMARY OF THE INVENTION

Meanwhile, it is desired to enhance durability of the connector.

One embodiment provides a connector capable of enhancing durability.

A connector according to one embodiment includes: a housing having a housing main body and a hood portion extending from the housing main body in a first direction and having a wiring inserted inside; and a rear holder inserted and fitted into the hood portion along the first direction. The housing includes an erroneous insertion preventing portion that is provided inside the hood portion and protrudes toward a side where the rear holder is inserted along the first direction, and a restraining portion that is provided inside the hood portion and restrains the rear holder from moving in a direction of being removed from the hood portion. The rear holder includes an insertion portion having a wiring insertion portion into which the wiring is inserted, the insertion portion being inserted into the hood portion, and a lock arm elastically deformable in a second direction, which intersects the first direction, and is engageable with the restraining portion, and the lock arm and the erroneous insertion preventing portion are opposite to each other with an interval in the second direction in a state where the insertion portion is inserted into the hood portion and the lock arm is restrained by the restraining portion.

According to one embodiment, the durability can be enhanced.

### BRIEF DESCRIPTION OF THE DRAWINGS

FIG. 1 is a perspective view of a connector according to an embodiment as viewed from one side in a first direction.

FIG. 2 is a perspective view of a housing of the connector according to the embodiment as viewed from the one side in the first direction.

FIG. 3 is a cross-sectional view of the housing according to the embodiment as viewed from a third direction.

FIG. 4 is a perspective view of a rear holder and a wiring of the connector according to the embodiment as viewed from the one side in the first direction.

FIG. 5 is a perspective view of the rear holder according to the embodiment as viewed from the other side in the first direction.

FIG. 6 is a view of the rear holder according to the embodiment as viewed from the other side in the first direction.

FIG. 7 is a perspective view illustrating a divided body constituting the rear holder according to the embodiment.

FIG. 8 is a cross-sectional view illustrating a state in which the rear holder according to the embodiment is to be inserted into a hood portion with the rear holder being oriented to an opposite side in the first direction.

### DETAILED DESCRIPTION OF THE INVENTION

Hereinafter, embodiments will be described with reference to the drawings. In the following description, constitutions having the same or similar functions are denoted by the same references. Further, redundant descriptions of these constitutions may be omitted. Note that constitutions described below do not limit the scope of the embodiments.

In the present disclosure, the terms are defined as follows. The term "connection" is not limited to a mechanical connection, and may include an electrical connection. That is, the term "connection" is not limited to a case where two elements that are connection targets are directly connected, and may include a case where two elements that are connection targets are connected with another element interposed therebetween. "Orthogonal" and "the same" may include "substantially orthogonal" and "substantially the same", respectively.

In the present disclosure, a first direction D1, a second direction D2, and a third direction D3 are defined as follows. The first direction D1 is an insertion/removal direction of a rear holder 4 with respect to a hood portion 22 of a housing 2 to be described later. One side D1a in the first direction D1 is a direction in which the rear holder 4 is removed from the hood portion 22 in the first direction D1. The other side D1b in the first direction D1 is a direction in which the rear holder 4 is inserted into the hood portion 22. The second direction D2 is a direction intersecting (for example, orthogonal to) the first direction D1. The third direction D3 is a direction intersecting (for example, orthogonal to) the first direction D1 and the second direction D2.

### EMBODIMENT

### 1. Constitution of connector

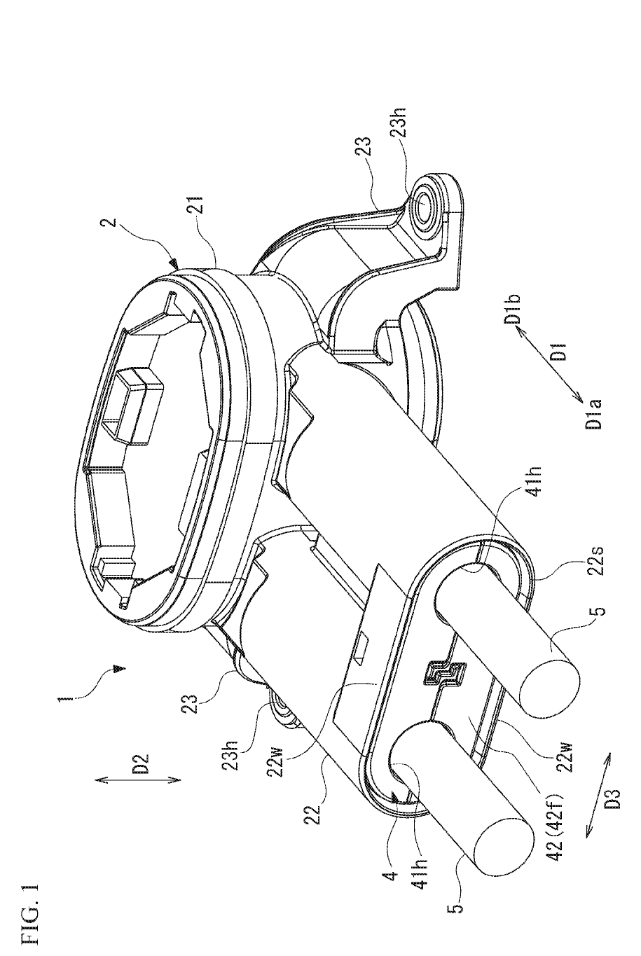

FIG. 1 is a perspective view of a connector according to an embodiment as viewed from one side in the first direction.

A connector 1 illustrated in FIG. 1 is connected to, for example, an in-vehicle device mounted on a vehicle such as an electric vehicle (EV), a hybrid electric vehicle (HEV), or a plug-in hybrid electric vehicle (PHEV).

The connector 1 is electrically connected to the in-vehicle device. The connector 1 is used to connect a wiring 5 to be described later to an in-vehicle device. In the present disclosure, the "in-vehicle device" is an electric device existing outside the connector 1. The in-vehicle device is, for example, a battery unit mounted on a vehicle or an inverter for driving a motor of the vehicle, but is not limited to these examples.

The connector 1 includes, for example, the housing 2 and the rear holder 4.

### 2. Housing

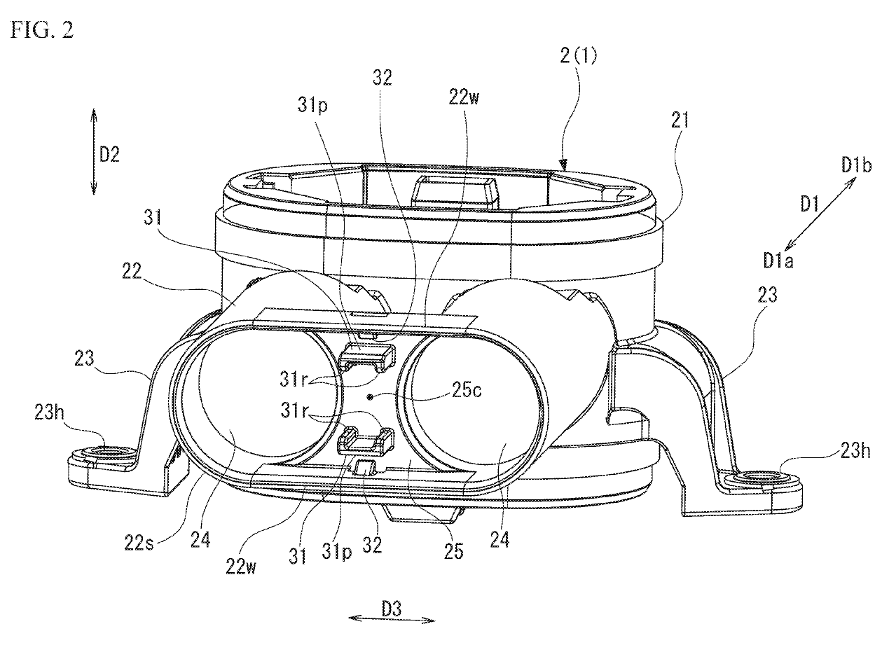

FIG. 2 is a perspective view of the housing of the connector according to the embodiment as viewed from the one side in the first direction.

As illustrated in FIG. 2, the housing 2 integrally includes a housing main body 21 and the hood portion 22. The housing 2 is made of a synthetic resin and has an insulating property.

### Housing main body

The housing main body 21 has a pair of legs 23. A bolt insertion hole 23h is formed in each of the pair of legs 23. The housing main body 21 is fastened to the in-vehicle device via bolts (not illustrated) inserted through the bolt insertion holes 23h of the pair of legs 23. A conductor (not illustrated) to which the wiring 5 is connected is accommodated in the housing main body 21.

### Hood portion

The hood portion 22 extends from the housing main body 21 in the first direction D1. The hood portion 22 is formed in an elliptical cylindrical shape having a minor axis in the second direction D2 and a major axis in the third direction D3 as viewed from the first direction D1. A pair of holes 24 through which the wiring 5 is inserted is formed in the hood portion 22. The pair of holes 24 is formed with an interval in the third direction D3. Each of the pair of holes 24 extends in the first direction D1 and communicates with the inside of the housing main body 21. In the hood portion 22, a partition wall 25 having a surface facing the one side D1a in the first direction D1 is formed between the pair of holes 24. The partition wall 25 is formed to be apart from an opening edge 22s on the one side D1a in the first direction D1 of the hood portion 22 on the other side D1b in the first direction D1 in the hood portion 22.

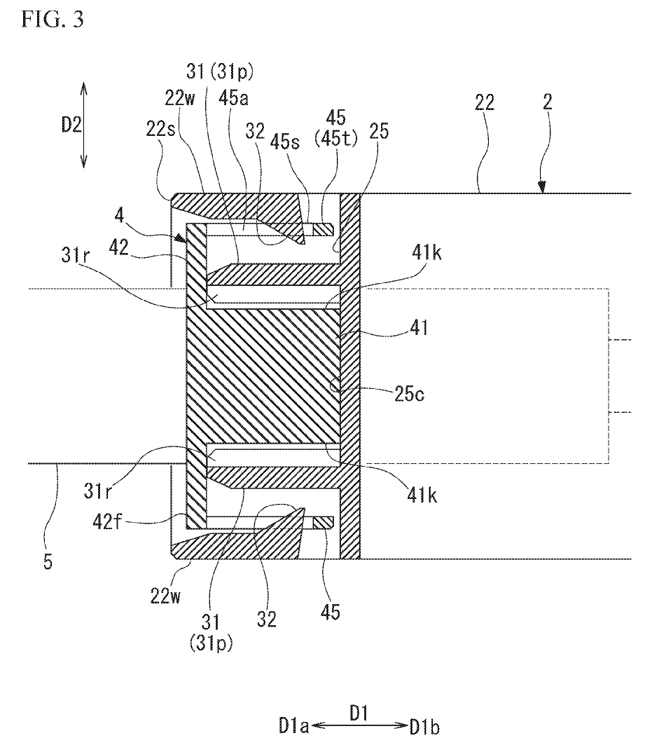

FIG. 3 is a cross-sectional view of the housing according to the embodiment as viewed from the third direction.

As illustrated in FIGS. 2 and 3, a pair of erroneous insertion preventing portions 31 and a pair of restraining portions 32 are formed in the hood portion 22.

The pair of erroneous insertion preventing portions 31 protrudes from the partition wall 25 to the one side D1a in the first direction D1, that is, a side where the rear holder 4 is removed from the hood portion 22. The pair of erroneous insertion preventing portions 31 is provided at a central portion in the third direction D3 in the hood portion 22. The pair of erroneous insertion preventing portions 31 is provided with an interval in the second direction D2. Each of the pair of erroneous insertion preventing portions 31 is provided to be apart from a wall-shaped portion 22w, which linearly extends in the third direction D3 of the hood portion 22, in a direction of approaching a center 25c of the partition wall 25 in the second direction D2 (hereinafter, this direction is referred to as an inner side in the second direction D2). The pair of erroneous insertion preventing portions 31 is formed to be line-symmetrical with respect to the center 25c of the partition wall 25 in the second direction D2.

The pair of erroneous insertion preventing portions 31 integrally includes a plate-shaped portion 31p and a pair of ribs 31r. The plate-shaped portion 31p is formed in a rectangular shape having a long side in the first direction D1 and a short side in the third direction D3 as viewed from the second direction D2. The pair of ribs 31r is formed on the inner side in the second direction D2 with respect to the plate-shaped portion 31p. The pair of ribs 31r projects to the inner side in the second direction D2 from both ends of the plate-shaped portion 31p in the third direction D3 and extends in the first direction D1. The pair of ribs 31r enhances the bending rigidity of the plate-shaped portion 31p in the second direction D2.

The pair of restraining portions 32 is formed in the wall-shaped portion 22w of the hood portion 22. Each of the pair of restraining portions 32 is a protrusion protruding to the inner side in the second direction D2 from the wall-shaped portion 22w. The pair of restraining portions 32 is formed at positions respectively overlapping the pair of erroneous insertion preventing portions 31 in the third direction D3. The restraining portion 32 is engaged with a lock arm 45 to be described later. With this engagement, the pair of restraining portions 32 restrains the rear holder 4 from moving in a direction of being removed from the hood portion 22.

### 3. Rear holder

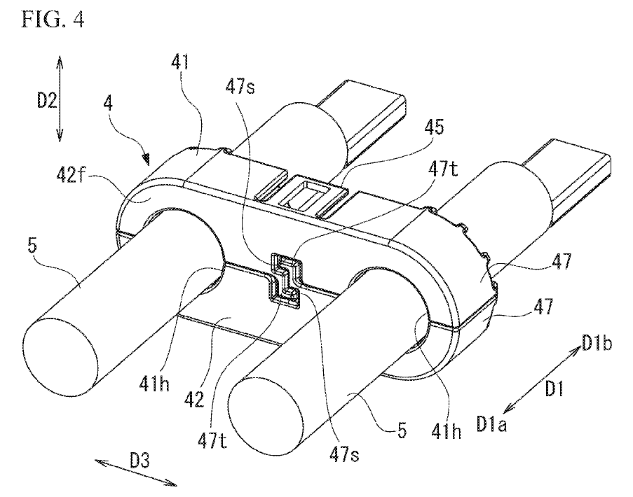

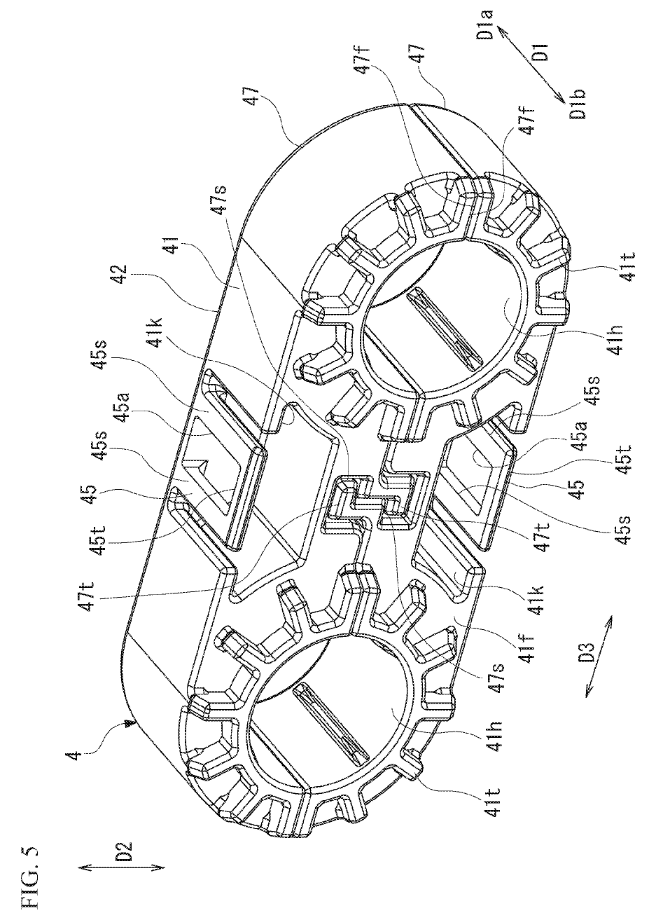

FIG. 4 is a perspective view of the rear holder and the wiring of the connector according to the embodiment as viewed from the one side in the first direction. FIG. 5 is a perspective view of the rear holder according to the embodiment as viewed from the other side in the first direction.

The rear holder 4 is inserted and fitted into the hood portion 22 along the first direction D1. As illustrated in FIGS. 4 and 5, the rear holder 4 integrally includes an insertion portion 41, a closing portion 42, and a pair of the lock arms 45.

### Insertion portion

As illustrated in FIG. 3, the insertion portion 41 is inserted into the hood portion 22. As illustrated in FIGS. 4 and 5, the insertion portion 41 is formed in a substantially elliptical shape as viewed in the first direction D1. A pair of wiring insertion portions 41h through which the wiring 5 is inserted is formed in the insertion portion 41. The pair of wiring insertion portions 41h penetrates the rear holder 4 in the first direction D1. As illustrated in FIG. 5, in the insertion portion 41, rib-shaped protrusions 41t that abut against the partition wall 25 are integrally formed on a surface 41f facing the other side D1b in the first direction D1 in the periphery of the wiring insertion portion 41h.

In addition, between the pair of wiring insertion portions 41h, a pair of recesses 41k recessed from the surface 41f to the one side D1a in the first direction D1 is formed. As illustrated in FIG. 3, the pair of recesses 41k is formed with an interval in the second direction D2. The erroneous insertion preventing portions 31 can be inserted into the pair of recesses 41k.

### Closing portion

As illustrated in FIGS. 1 and 3, the closing portion 42 closes a gap between the opening edge 22s of the hood portion 22 and the wiring 5 in a state where the insertion portion 41 is inserted into the hood portion 22. The closing portion 42 has a flat surface portion 42f that expands along a plane intersecting the first direction D1 and faces the one side D1a of the first direction D1.

### Lock arm

As illustrated in FIGS. 3 and 5, the pair of lock arms 45 is formed on an outer side in the second direction D2 with respect to the pair of recesses 41k. In other words, the pair of lock arms 45 defines a part of the pair of recesses 41k, respectively. Each of the pair of lock arms 45 is formed in a plate shape expanding along a plane intersecting the second direction D2.

Each of the pair of lock arms 45 integrally includes a pair of extending portions 45s and a coupling portion 45t. The pair of extending portions 45s is provided with an interval in the third direction D3. Each of the pair of extending portions 45s extends from the closing portion 42 to the other side D1b in the first direction D1. The coupling portion 45t extends in the third direction D3 and couples distal ends of the pair of extending portions 45s to each other. With this structure, each of the pair of lock arms 45 has a rectangular shape as viewed from the second direction D2, and has a notch 45a, which penetrates the lock arm 45 in the second direction D2, at an intermediate portion in the third direction D3. Each of the pair of lock arms 45 is elastically deformable in the second direction D2 on the coupling portion 45t side about a proximal end where the pair of extending portions 45s is connected to the closing portion 42.

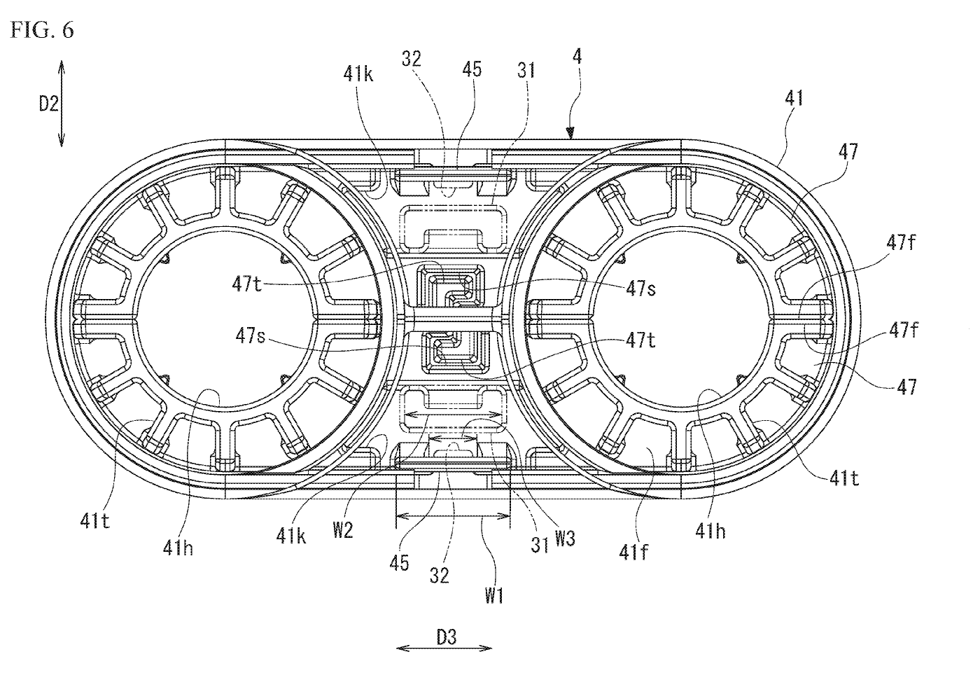

FIG. 6 is a view of the rear holder according to the embodiment as viewed from the other side in the first direction. In FIG. 6, positions of the pair of erroneous insertion preventing portions 31 and the pair of restraining portions 32 in a state where the insertion portion 41 of the rear holder 4 is inserted into the hood portion 22 are indicated by two-dot chain lines.

As illustrated in FIGS. 3 and 6, in the state where the insertion portion 41 of the rear holder 4 is inserted into the hood portion 22, each of the pair of lock arms 45 is provided apart from the pair of erroneous insertion preventing portions 31 on the outer side in the second direction D2. The pair of lock arms 45 is opposite to the pair of erroneous insertion preventing portions 31, respectively, in the second direction D2. An interval between each of the pair of lock arms 45 and each of the pair of erroneous insertion preventing portions 31 in the second direction D2 is set to an interval at which the lock arm 45 abuts against the erroneous insertion preventing portion 31 when being deformed toward the inner side in the second direction D2. With this setting, excessive deformation of the lock arm 45 is regulated.

As illustrated in FIG. 6, a width dimension W1 of each of the lock arms 45 in the third direction D3 is equal to or larger than a width dimension W2 of the erroneous insertion preventing portion 31 in the third direction D3. In addition, an opening dimension W3 of the notch 45a of the lock arm 45 in the third direction D3 is smaller than the width dimension W2 of the erroneous insertion preventing portion 31.

### Divided body

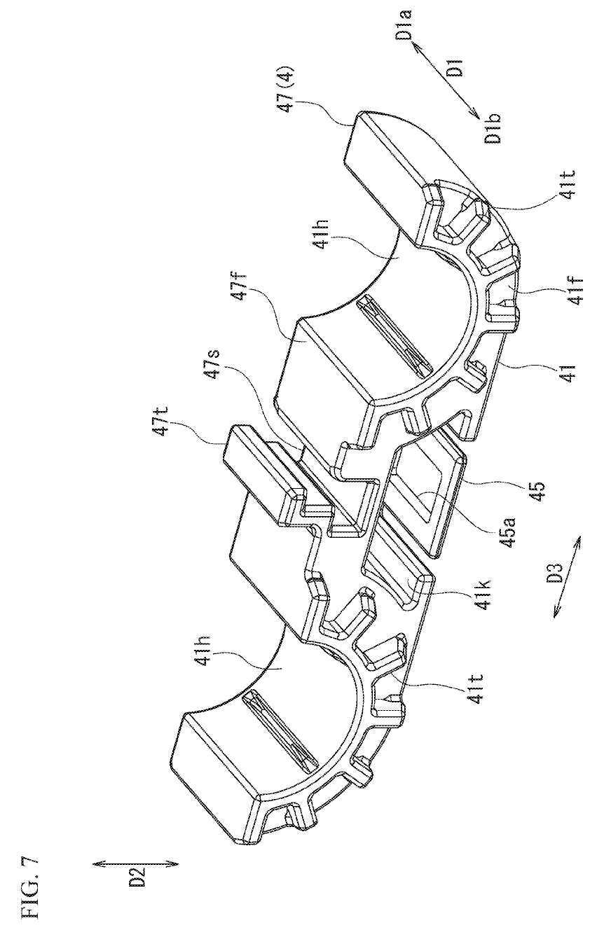

FIG. 7 is a perspective view illustrating a divided body constituting the rear holder according to the embodiment.

As illustrated in FIGS. 5 to 7, the rear holder 4 is formed by combining a pair of divided bodies 47 obtained by dividing the rear holder 4 into two parts in the second direction D2. Each of the pair of divided bodies 47 has a point-symmetrical shape in the second direction D2.

Each of the pair of divided bodies 47 has an abutment surface 47f against the other divided body 47, an engagement protrusion 47t, and an engagement recess 47s. The abutment surface 47f is a flat surface expanding along a plane intersecting the second direction D2. The engagement protrusion 47t protrudes from the abutment surface 47f in the second direction D2. The engagement protrusion 47t is formed in, for example, an L shape as viewed from the first direction D1. The engagement recess 47s is recessed from the abutment surface 47f in the second direction D2. The engagement recess 47s is formed in an L shape so as to mesh with the engagement protrusion 47t as viewed from the first direction D1.

When the pair of divided bodies 47 is combined as illustrated in FIGS. 5 and 6, the abutment surface 47f of one divided body 47 and the abutment surface 47f of the other divided body 47 abut against each other, and the engagement protrusion 47t meshes with the engagement recess 47s. With this constitution, the pair of divided bodies 47 is coupled to each other to form the rear holder 4.

### Assembling of rear holder to housing

As illustrated in FIG. 4, the wiring 5 is brought in advance into a state of being sandwiched between the pair of divided bodies 47 of the rear holder 4 in order to assemble the rear holder 4 to the housing 2. Thereafter, as illustrated in FIG. 3, the insertion portion 41 of the rear holder 4 is inserted into the hood portion 22. Further, the rear holder 4 is assembled to the housing 2 by engaging the pair of lock arms 45 with the pair of restraining portions 32, respectively.

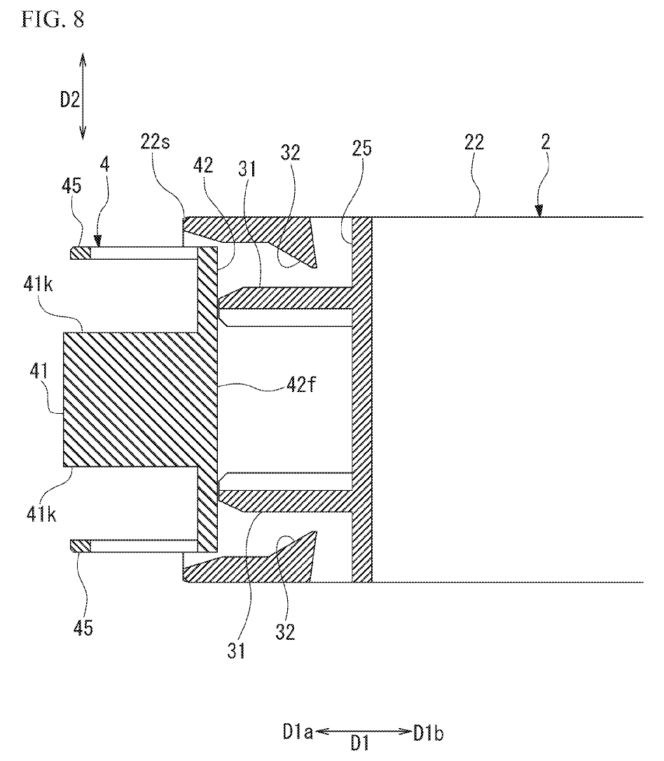

FIG. 8 is a cross-sectional view illustrating a state in which the rear holder according to the embodiment is to be inserted into the hood portion with the rear holder being oriented to an opposite side in the first direction.

If the rear holder 4 is erroneously oriented to the opposite side in the first direction D1 as illustrated in FIG. 8 during assembling of the rear holder 4 to the housing 2, the flat surface portion 42f of the closing portion 42 abuts against the pair of erroneous insertion preventing portions 31. As a result, the rear holder 4 cannot be inserted into the hood portion 22, and erroneous assembling of the rear holder 4 is prevented.

### 4. Advantages

In the present embodiment, the erroneous insertion preventing portion 31 is provided inside the hood portion 22 of the housing 2, and the lock arm 45 of the rear holder 4 is opposite to the erroneous insertion preventing portion 31 in the second direction D2 with an interval in a state where the insertion portion 41 is inserted inside the hood portion 22. With this constitution, the erroneous insertion preventing portion 31 can suppress erroneous insertion of the rear holder 4. In addition, since the lock arm 45 is accommodated inside the hood portion 22, damage to the lock arm 45 due to an external force is suppressed. Furthermore, the lock arm 45 abuts against the erroneous insertion preventing portion 31, thereby suppressing the excessive deformation. As a result, it is possible to prevent the erroneous insertion of the rear holder 4 and enhance durability.

In the present embodiment, the width dimension W1 of the lock arm 45 is equal to or larger than the width dimension W2 of the erroneous insertion preventing portion 31. With this constitution, when the lock arm 45 is excessively deformed, the lock arm 45 comes into contact with the entire erroneous insertion preventing portion 31 in the width direction (the third direction D3). As a result, local stress is prevented from being focused on the lock arm 45, which can contribute to improvement in durability of the lock arm 45.

In the present embodiment, since the notch 45a is provided, the lock arm 45 is more likely to be elastically deformed in the second direction D2, and can be easily engaged with and disengaged from the restraining portion 32. In addition, the opening dimension W3 of the notch 45a is smaller than the width dimension W2 of the erroneous insertion preventing portion 31. With this constitution, when the lock arm 45 is excessively deformed, the lock arm 45 favorably abuts against the erroneous insertion preventing portion 31, and the excessive deformation of the lock arm 45 can be effectively suppressed.

In the present embodiment, the erroneous insertion preventing portion 31 integrally includes the plate-shaped portion 31p and the rib 31r. With this constitution, it is possible to enhance the rigidity of the erroneous insertion preventing portion 31 when the lock arm 45 is excessively deformed.

In the present embodiment, the rear holder 4 includes the closing portion 42 having the flat surface portion 42f expanding to intersect the first direction D1. With this constitution, when the rear holder 4 is to be inserted into the hood portion 22 with the rear holder 4 being oriented to the opposite side in the first direction D1, the flat surface portion 42f abuts against the erroneous insertion preventing portion 31, so that the erroneous insertion into the hood portion 22 can be satisfactorily prevented.

### 5. Modification Examples

Next, several modification examples will be described. Note that a constitution other than those described below in each modification example is the same as the constitution of the above-described embodiment.

Although the rear holder 4 is formed by combining the pair of divided bodies 47 in the above-described embodiment, the invention is not limited thereto. The constitution of the rear holder 4 can be changed as appropriate. In addition, each of the hood portion 22 and the rear holder 4 has the elliptical shape as viewed from the first direction D1, but the invention is not limited thereto. The shapes of the hood portion 22 and the rear holder 4 may be other shapes as appropriate. In addition, the shape and constitution of the housing main body 21 of the housing 2 are merely examples, and other shapes and constitutions may be appropriately adopted.

Several embodiments and modification examples have been described above. However, the embodiments and the modification examples are not limited to the examples described above. For example, a plurality of embodiments may be implemented in combination with each other.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### REFERENCE SIGNS LIST

1 Connector

2 Housing

4 Rear holder

5 Wiring

21 Housing main body

22 Hood portion

22s Opening edge

31 Erroneous insertion preventing portion

31p Plate-shaped portion

31r Rib

32 Restraining portion

41 Insertion portion

41h Wiring insertion portion

42 Closing portion

42f Flat surface portion

45 Lock arm

45a Notch

W1 Width dimension

W2 Width dimension

W3 Opening dimension

What is claimed is:

1. A connector comprising:
a housing having a housing main body and a hood portion that extends from the housing main body in a first direction and has a wiring inserted inside; and
a rear holder inserted and fitted into the hood portion along the first direction,
wherein the housing includes:
an erroneous insertion preventing portion that is provided inside the hood portion and protrudes toward a side where the rear holder is inserted along the first direction; and
a restraining portion that is provided inside the hood portion and restrains the rear holder from moving in a direction of being removed from the hood portion,
wherein the rear holder includes:
an insertion portion having a wiring insertion portion through which the wiring is inserted, the insertion portion being inserted into the hood portion; and
a lock arm elastically deformable in a second direction, which intersects the first direction, and is engageable with the restraining portion, and
wherein the lock arm and the erroneous insertion preventing portion are opposite to each other with an interval in the second direction in a state where the insertion portion is inserted into the hood portion and the lock arm is restrained by the restraining portion.

2. The connector according to claim 1, wherein
the lock arm has a plate shape expanding along a plane intersecting the second direction, and
a width dimension of the lock arm in a third direction intersecting the first direction and the second direction is equal to or larger than a width dimension of the erroneous insertion preventing portion in the third direction.

3. The connector according to claim 2, wherein
the lock arm includes a notch, which penetrates the lock arm in the second direction, at an intermediate portion in the third direction, and
an opening dimension of the notch in the third direction is smaller than the width dimension of the erroneous insertion preventing portion in the third direction.

4. The connector according to claim 1, wherein
the erroneous insertion preventing portion integrally includes:
a plate-shaped portion that is provided apart from the lock arm on one side in the second direction and expands along a plane intersecting the second direction; and
a rib that projects from the plate-shaped portion to the one side in the second direction and extends along the first direction.

5. The connector according to claim 1, wherein
the rear holder further includes a closing portion that closes a gap between an opening edge of the hood portion and the wiring in a state where the insertion portion is inserted into the hood portion, and
the closing portion includes a flat surface portion expanding along a plane intersecting the first direction.
